(19) United States
(12) Patent Application Publication
(10) Pub. No.: US 2012/0173453 A1
(43) Pub. Date: Jul. 5, 2012

(54) System and method for establishing a structured investment

(75) Inventors: Christina D. Sfakianos, New York, NY (US); Adam M. Green, Westport, CT (US); Steven Tod Kern, Larchmont, NY (US)

(73) Assignee: JPMorgan Chase & Co, New York, NY (US)

(21) Appl. No.: 11/442,487

(22) Filed: May 26, 2006

Related U.S. Application Data
(60) Provisional application No. 60/773,461, filed on Feb. 15, 2006.

(51) Int. Cl. G06Q 40/06; G06Q 40/04

(52) U.S. Cl. 705/36 R; 705/37

(57) ABSTRACT

A structured investment product provides a return that substantially tracks returns from at least two different financial instruments. To establish the structured investment product a forward starting option on a first financial variable is acquired at a first time. A financial instrument is also acquired. Purchase orders for shares of the structured investment and investment capital are received. At a second time, options on the first financial variable are acquired. Certain predefined terms of the forward starting option and certain predefined terms of the option are the same. More of the financial instrument is acquired.

This application claims priority to U.S. Provisional Application Ser. No. 60/773,461, entitled System and Method for Establishing an Index Option Trust, filed Feb. 15, 2006, the disclosure of which is incorporated herein by reference.

### BACKGROUND

Certain structured investment products are available to institutional investors, but may not be available to consumer investors. Systems and methods are needed to provide the same structured investment products to consumer investors, or structured products that track or provide the same or substantially the same returns to consumer investors.

The preceding description is not to be construed as an admission that any of the description is prior art relative to the present invention.

### SUMMARY OF THE INVENTION

In one aspect, embodiments of the system and method establish a structured investment product, the investment product providing a return that substantially tracks returns from at least two different financial instruments. The system and method comprise acquiring at a first time a forward starting option on a first variable tracked by a financial market. The system and method further comprise acquiring a financial instrument. The system and method further comprise receiving investment capital as purchase orders for shares of the structured investment product, and acquiring at a second time an option on the first variable. Certain predefined terms of the forward starting option and certain predefined terms of the option are the same. The system and method further comprise acquiring more of the financial instrument.

In another aspect of the system and method, the structured investment product is offered by a pooled investment vehicle. In another aspect of the system and method, the pooled investment vehicle is a registered investment company. In another aspect of the system and method, the structured investment product is a unit investment trust. In another aspect, the system and method further comprise receiving seed assets. In another aspect of the system and method, acquiring at the first time the forward starting option on the first variable, and acquiring the financial instrument uses at least some of the seed assets. In another aspect of the system and method, acquiring at the second time the option on the first variable, and acquiring more of the financial instrument uses at least some of the investment capital. In another aspect of the system and method, acquiring at the first time the forward starting option on the first variable further comprises acquiring at the first time a forward starting call option on the first variable. In another aspect of the system and method, acquiring at the first time the forward starting option on the first variable further comprises acquiring at the first time a forward starting put option on the first variable. In another aspect of the system and method, acquiring at the first time the forward starting option on the first variable further comprises acquiring at the first time a forward starting exotic option on the first variable. In another aspect of the system and method, acquiring the financial instrument further comprises purchasing the financial instrument. In another aspect of the system and method, acquiring the financial instrument further comprises selling the financial instrument. In another aspect of the system and method, acquiring at the second time the option on the first variable further comprises acquiring at the second time a call option on the first variable. In another aspect of the system and method, acquiring at the second time the option on the first variable further comprises acquiring at the second time a put option on the first variable. In another aspect of the system and method, acquiring at the second time the option on the first variable further comprises upsizing the previously acquired forward starting option. In another aspect of the system and method, acquiring more of the financial instrument further comprises acquiring more of the financial instrument with a portion of the investment capital. In another aspect of the system and method, the second time is one or more days after the first time. In another aspect of the system and method, acquiring the financial instrument occurs at the first time. In another aspect of the system and method, acquiring more of the financial instrument occurs at the second time. In another aspect of the system and method, strike price is one of the predefined terms that is the same. In another aspect of the system and method, counterparty is one of the predefined terms that is the same. In another aspect of the system and method, acquiring the financial instrument further comprises acquiring at the first time a forward starting option on a second variable tracked by a financial market. In another aspect of the system and method, acquiring more of the financial instrument further comprises acquiring at the second time a call option on the financial instrument. In another aspect of the system and method, acquiring more of the financial instrument further comprises acquiring at the second time a put option on the financial instrument. In another aspect, the system and method further comprise filing a registration statement for the structured investment product after acquiring at the first time the forward starting option.

In another aspect, embodiments of the system and method establish a structured investment product, the investment product providing a return that substantially tracks returns from at least two different financial instruments. The system and method comprise acquiring at a first time a first forward starting option on a first variable tracked by a financial market. The system and method further comprise acquiring a financial instrument. The system and method further comprise receiving investment capital as purchase orders for shares of the structured investment product, and acquiring at a second time a second forward starting option on the first variable tracked by a financial market. Certain predefined terms of the first and second forward starting options are the same. The system and method further comprise acquiring more of the financial instrument.

In another aspect, embodiments of the system and method establish a structured investment product, the investment product providing a return that substantially tracks returns from at least two different financial instruments. The system and method comprise acquiring at a first time a forward starting derivative on a first variable tracked by a financial market. The system and method further comprise acquiring a financial instrument. The system and method further comprise receiving investment capital as purchase orders for shares of the structured investment product and acquiring at a second time a derivative on the first variable. Certain predefined terms of the forward starting derivative and certain predefined terms of the derivative are the same. The system and method further comprise acquiring more of the financial instrument.

In another aspect of the system and method, the forward starting derivative is a forward starting option, and the derivative is an option. In another aspect of the system and method, the forward starting derivative is a forward starting forward, and the derivative is a forward. In another aspect of the system and method, the forward starting derivative is a forward starting swap, and the derivative is a swap.

In another aspect, embodiments of the system and method establish a structured investment product, the investment product providing a return that substantially tracks returns from at least two different financial instruments. The system and method comprise acquiring at a first time a first forward starting derivative on a first variable tracked by a financial market. The system and method fiuther comprise acquiring a financial instrument. The system and method further comprise receiving investment capital as purchase orders for shares of the structured investment product, and acquiring at a second time a second forward starting derivative on the first variable. Certain predefined terms of the first and second forward starting derivatives are the same. The system and method further comprise acquiring more of the financial instrument.

In another aspect, embodiments of the system and method establish a structured investment product. The system and method comprise acquiring at a first time a forward starting option on a first variable tracked by a financial market. The system and method further comprise receiving investment capital as purchase orders for shares of the structured investment product, and acquiring at a second time an option on the first financial variable with at least a portion of the investment capital. Certain predefined terms of the forward starting option and certain predefined terms of the option are the same.

In another aspect, the system and method further comprise acquiring at the first time a forward starting option on a second variable tracked by a financial market. In another aspect, the system and method further comprise acquiring at the second time an option on a second variable tracked by a financial market. In another aspect of the system and method, the first variable comprises a basket of variables. In another aspect of the system and method, the forward starting option is a forward starting put option. In another aspect of the system and method, the forward starting option is a forward starting call option. In another aspect of the system and method, the forward starting option is a forward starting combination of a put and a call option. In another aspect of the system and method, the forward starting option is a forward starting combination of multiple put options. In another aspect of the system and method, the forward starting option is a forward starting combination of multiple calls options. In another aspect of the system and method, the forward starting option is a forward starting combination of multiple put and multiple call options. In another aspect of the system and method, acquiring at a second time an option on the financial variable further comprises upsizing the previously acquired forward starting option.

The foregoing specific aspects are illustrative of those which can be achieved and are not intended to be exhaustive or limiting of the possible advantages that can be realized. Thus, the objects and advantages will be apparent from the description herein or can be learned from practicing the invention, both as embodied herein or as modified in view of any variations which may be apparent to those skilled in the art. Accordingly, the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates an example system according to an embodiment; and

FIG. 2 illustrates steps in an example method according to an embodiment.

It is understood that the drawings are for illustration only and are not limiting.

### DETAILED DESCRIPTION OF THE DRAWINGS

The purchase or sale of a forward starting option (“FSO”) is used in the initial seeding and deposit as part of the formation of a Unit Investment Trust (“UIT”) that also holds options that are purchased or sold when proceeds from the sale of UIT units are invested in UIT assets. Terms of the forward starting option and the options purchased or sold, such as the strike price and expiration are or become the same.

### EXAMPLE SYSTEM

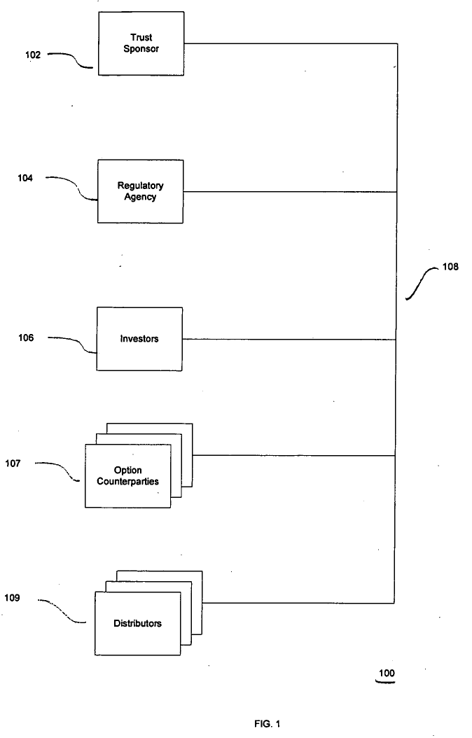

Referring to FIG. 1, an example system 100 according to one embodiment includes trust sponsor 102, regulatory agency 104, investors 106, option counterparties 107 and distributors 109. Trust sponsor 102, regulatory agency 104, investors 106, option counterparties 107 and distributors 109 are interconnected by network 108. Although not illustrated, trust sponsor 102, regulatory agency 104, investors 106, option counterparties 107 and distributors 109 include various electronic and computer components, including central processor units (CPUs), memory (RAM, ROM, etc.), fixed and/or removable code storage devices (hard drives, floppy drives, CD, DVD, flash memory, etc.), input/output devices (printers, pointers, keyboards, displays, etc.) and network communication devices (Ethernet, NIC, WiFi, modems, etc.). Network 108 may include wired and wireless networks, such as an intranet, an extranet, the Internet, PSTN, etc. Computer software code including program instructions for use by trust sponsor 102, regulatory agency 104, investors 106, option counterparties 107 and distributors 109 can be transmitted as an information signal for download over network 108, and stored on the fixed or removable code storage devices.

### EXAMPLE METHOD

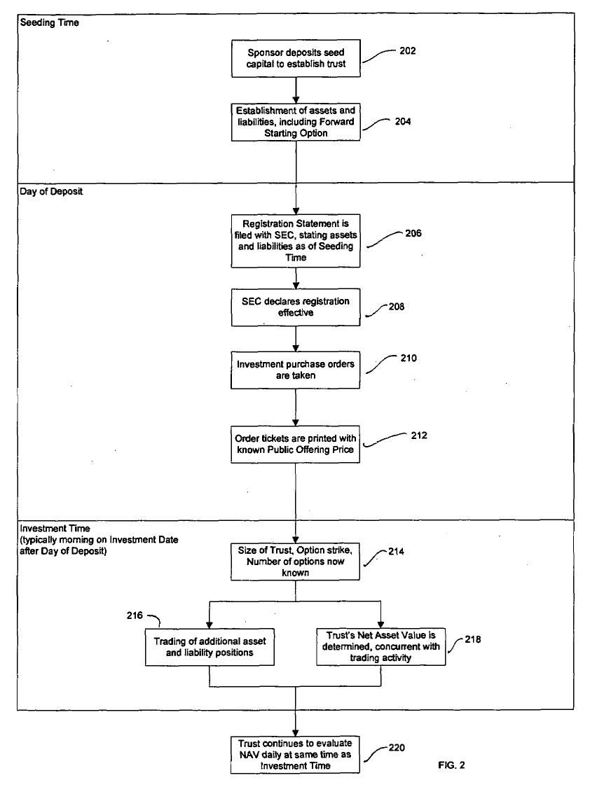

In FIG. 2 steps to establish a trust in an example method cover three days. Seeding time occurs on the first day, the day of deposit occurs on the second day and proceeds from the sale of UIT units are invested in UIT Assets on the third day.

At step 202 on the first day (seeding time), the sponsor deposits seed capital or assets to establish the trust. The minimum amount of seed capital or assets required for deposit may be set by regulation, such as $100,000. In one example the seed capital or assets deposited by the sponsor is about $150,000.

At step 204, the assets/liabilities of the trust are established through investment of the seed capital. One of the assets/liabilities that is acquired (acquired referring to either a purchase or sale, and including upsizing a previously acquired asset or liability) as part of the investment is a Forward Starting Option on an index, such as the S&P 500 Index™. Upsizing includes without limitation amending the premium amount, the number of options, or any other term relating to the size of an option, in each case with respect to the previously acquired Forward Starting Option. The option might be a call or a put (or some combination of a call and a put, multiple puts, multiple calls, multiple puts and multiple calls, etc), and the acquisition may be a purchase or sale of the option. The option might be a call spread. The option might also be an exotic option, such as but not limited to binary options, knock-out or knock-in options, barrier options, and digital options. The purchase or sale may be made using competitive bids or offers on the FSO.

The FSO allows the present purchase or sale of an option that at a future time has one of its terms (each such term a “forward starting variable”) (such as strike price, barrier level and/or cap) determined. The FSO will specify a number of terms, including but not limited to:
the third-party counterparty for the option;
the expiration date or term of the option;
the exercise terms of the option (e.g., option style, such as American or European; and exercise period, if applicable); and
the dates and times at which the numerical value of the forward starting variables will be determined and the manner in which each will be determined.

As an example, in a forward starting call option the premium amount and strike price are each defined as specific percentages of a reference financial variable, such as the S&P 500 Index level on a specific date and at a specific future time. For ease of explanation, we will refer to that specific date and specific future time as the “FSO Determination Date and Time.” The specific date could be either the present day or a future day. Typically the strike price and premium amount of the FSO will not be known until the FSO Determination Date and Time.

For ease of explanation, we will refer to the present purchase or sale as the “FSO Execution Time.” The FSO Determination Date and Time will be specified at the FSO Execution Time. Although some terms may not yet have numerical values, the manner of determination of terms that do not yet have numerical values will also be specified at the FSO Execution Time.

At the FSO Execution Time, the numerical value of the strike price, barrier level or cap of the option will be specified as a specific percentage of the reference financial variable. Also at the FSO Execution Time, the dollar amount of the option premium will be specified as a specific percentage of the reference financial variable.

The option strike price is usually determined in reference to the reference variable or a specified percentage of the reference variable at some specified time in the future (e.g., 80%, 100% or 120%). For example, the strike price in an FSO may be defined as a percentage of the value of the reference variable at the FSO Determination Date and Time. At such date and time, the numerical value of the strike price will be determined based on the value of the reference variable.

In one embodiment, the option strike price is a set percentage of the opening or closing level of an index (e.g., the S&P 500 Index™) on the first trading day following the day of deposit. In the embodiment illustrated in FIG. 2, the option strike price is determined at the market opening or closing on the third day, and that market opening or closing on the third day is therefore the FSO Determination Date and Time.

At step 204, the actual number of options purchased or sold is not known because the number of options purchased or sold is determined by a formula, and some inputs into the formula will only be known at the FSO Determination Date and Time.

At step 206 in the morning of the second day (e.g., 11:00 a.m. on the day of deposit), a registration statement for the trust is filed with the Securities and Exchange Commission (the “SEC”). Among other things, the registration statement lists the assets and liabilities, if any, of the trust as of the seeding time.

At step 208 the SEC declares the registration statement effective. Step 208 could occur as soon as a few hours after step 206 on the second day (e.g., 1:00 p.m. on the day of deposit).

As soon as the SEC declares the registration statement effective, the trust can begin taking investment purchase orders through distributors 109, which occurs at step 210. Investors place their orders with investment specialists who are employees of distributors 109, and then those distributors route the orders to the trust. Investment specialists need to know the public offering price on the second day in order to complete order tickets at step 212 for the orders they took at step 210. Before the trust units are offered for sale at step 210, the public offering price is determined. The public offering price is the price an investor pays for each unit of the trust (e.g., $10.00 or $1000.00 plus sales charges and fees). Typically the public offering price is determined at step 202 or step 204 and can be included in the registration statement that is filed with the SEC at step 206. As such, the public offering price will be known prior to step 210 and step 212.

After step 212, at the end of the second day (the day of deposit), and thus after receipt of all orders for that day, the trust knows the final total order size for that day. Once the total order size is known, the trust can determine the amount of cash available to spend on option premium if the trust will be purchasing options or the amount of cash the trust would like to receive as option premium if the trust will be selling options. The number of options that will be purchased or sold by the trust will be known at the opening or closing on day three, subject to market conditions when the options are purchased or sold.

Although not illustrated, the same third-party counterparty with which the trust purchased or sold the FSO at step 204 enters into additional options with the trust at steps 214, 216 and 218. For example, if the first option is an option on the S&P 500 Index™, the additional options could be options on the S&P 500 Index, an ETF that tracks the S&P 500 Index, a SPDR or any other underlying that yields the same or substantially the same economic result. In investing the funds received from the investors at step 210, the trust purchases from or sells to the third-party counterparty options on the index with terms identical to the FSO at the opening or closing on day three. The total number of options in the trust at step 220 will equal the sum of the FSOs purchased or sold at the seeding time and the incremental identical options purchased or sold at step 216.

Although not required, the sponsor may elect to recover some or all of its seed capital. The sponsor accomplishes this by selling the trust units it acquired in respect of its investment of seed capital.

In the embodiment illustrated in FIG. 2, after steps 214, 216 and 218 the level of the reference variable and the option strike price which were to be determined at a future time will be known, because those steps occur simultaneously or almost simultaneously with the FSO Determination Date and Time, and the FSO Execution Time. At that time, all terms of the options (the FSO and later purchased or sold options) will be known, as well as the number of options per trust unit.

At step 220, on succeeding trading days, the trust will continue to evaluate NAV daily at the same time of day as the Investment Time (defined below) (e.g., market open or close).

In FIG. 2, the steps are illustrated spanning three days. However, it is also possible that seeding time and the day of deposit occur on the same day, with steps 202 and 204 occurring before step 206. It is also possible that seeding time, the day of deposit and Investment Date all occur on the same day, with steps 202 and 204 occurring before step 206, and with steps 206, 208, 210 and 212 occurring before steps 214, 216 and 218.

In FIG. 2, step 202 (sponsor deposit of seed capital) precedes step 204 (establishment of assets and liabilities of the trust). However, it is also possible that the sponsor deposits the assets and liabilities of the trust as its deposit of seed capital, in effect combining steps 202 and 204.

In FIG. 2, the day of deposit is illustrated as a single day with all investment purchase orders taken during that single day. However, in other embodiments, which are not illustrated, it is possible that the trust may take investment purchase orders from investors over multiple days or even weeks.

When the trust takes purchase orders over multiple days or weeks, there are multiple embodiments. In one embodiment, a UIT may purchase or sell a FSO on the day of seeding and then again on each day on which proceeds from the sale of UIT units are invested in UIT assets. Each such day is referred to for convenience as an “Investment Date.” On the day of seeding and on each such Investment Date (not including the final Investment Date), the UIT will purchase or sell a FSO at or about the same time of day, referred to for convenience as the “Investment Time.” After the purchase or sale of a FSO on the day of seeding, and the purchase or sale of a FSO at or about the Investment Time on each of several Investment Dates (not including the final Investment Date), the UIT then may purchase or sell an option at or about the Investment Time on the final Investment Date. In this embodiment, the FSO Determination Date and Time will correspond closely to that Investment Time on the final Investment Date.

In another embodiment, a UIT may purchase or sell a FSO on the day of seeding and then may purchase or sell a FSO at or about the Investment Time on each of several Investment Dates (including the final Investment Date). In this embodiment, the FSO Determination Date and Time may or may not correspond to the Investment Time on the final Investment Date. For example, the FSO Determination Date and Time may be at a time on the final Investment Date later than the Investment Time or may be on a day after the final Investment Date.

Referring back to the embodiment illustrated in FIG. 2, when a UIT purchases or sells a FSO on the day of seeding and then purchases or sells an option at the Investment Time on a single Investment Date, the FSO Determination Date and Time will correspond closely to that Investment Time on the Investment Date.

Although not illustrated, put and/or call options can be combined with each other, as well as with other financial instruments or contracts. Further, other derivative instruments, such as a swap or a forward can be substituted for an option. In these embodiments a forward starting forward or a forward starting swap would be used.

In one embodiment, the FSO and option are on an established index. It is also possible in other embodiments for the FSO and option to be on a variable that is tracked by a financial market, such as LIBOR, not simply an established index.

Having described various embodiments of the invention, it is helpful to understand some of the benefits. As investment vehicles for providing pooled investment choices to the consumer investor, the SEC has approved use of “open-end investment companies,” “closed-end investment companies,” and “unit investment trusts” (“UITs”). Open-end investment companies are often referred to as mutual finds, and all three pooled investment vehicles are considered to be “investment companies.” Additional detail on these different types of investment companies is provided by the SEC at: http://www.sec.gov/answers/uit.htm, and http://www.sec.gov/investor/pubs/inwsmf.htm. The descriptions provided at those sites are incorporated herein by reference.

Techniques and financial structures have been developed over time to provide investment products to consumer investors that were previously only available to institutional or high net worth investors. For example, an institutional or high net worth investor that wanted to track the total return performance of an established index consisting of a basket of securities (e.g., the S&P 500 Index™) could purchase all of the securities in the index in the representative percentages, and the performance of that group of securities should exactly or almost exactly match the total return of the index. The cost to purchase such a basket of securities to match an established index might run several million dollars. For an institutional or high net worth investor, an investment of that amount may generally not be a problem. However, most consumer investors do not have sufficient funds to replicate an established index like the S&P 500 Index™ by purchasing all of the securities in the index. Over time, mutual funds and exchange traded funds have evolved to give consumer investors access to a number of financial products that closely track the S&P 500 Index™ at substantially lower investment levels.

The embodiments described herein have particular applicability to a UIT or a closed-end investment company. A UIT, which has a fixed termination date and dissolves on that date, sells redeemable units through a public offering during a limited offering period. The SEC has established a number of requirements for a UIT. One of the first steps in forming a typical UIT is establishing the trust as a legal entity. The trust's sponsor may establish the UIT by providing as seed capital at least $100,000 worth of assets that form a complete basket of financial instrument(s) that will be held by the UIT.

As an example, if the UIT is intended to track the performance of a group of bonds that all mature on a specific date, then at seeding time, the trust purchases the selected set of the bonds using seed capital. Generally, once the trust holds the selected set of bonds in its portfolio, typically in the same proportions that will make up the portfolio, a registration statement is filed with the SEC for the UIT. After that registration statement becomes effective, trust units can be offered for purchase and orders for units can be confirmed throughout the offering period.

Assuming that all of the SEC requirements for establishing a UIT are satisfied, it is conceivable for a UIT to hold many different and varied types of financial instruments. Typically the instruments held by UITs will include various securities, whether debt instruments (e.g., bonds) or equity securities (e.g., stocks). Financial instruments may further include financial contracts, whether assets or liabilities.

One key strength of a UIT is that it offers a consumer investor the opportunity to invest in a fixed portfolio of securities by means of the simple purchase of a unit of the UIT. The consumer investor can thereby gain exposure to that portfolio without facing the expense or difficulty of separately acquiring each security in the portfolio. A UIT's portfolio is static, unmanaged and transparent; these characteristics may be of particular appeal to consumer investors who are not seeking active management and want to maintain control over the investment.

Another strength of a UIT is its defined term. As each UIT has a predetermined termination date, a UIT is particularly well-suited to an investment view that includes a time horizon. For example, a UIT will appeal to consumer investors with a market view consistent with the UIT's fixed portfolio and defined term.

The embodiments described embrace these two strengths of a UIT, its fixed portfolio and defined term, and incorporate derivatives into the UIT's portfolio in order to offer structured investments more broadly in the United States. Structured investments offer defined pay-off profiles that differ from those of direct investments in securities. This difference is typically achieved by embedding a derivative or the economics of a derivative in the structured investment. The purpose of embedding a derivative in a structured investment is to create a pay-off profile that does not have a linear correspondence to the pay-off of the asset underlying the derivative. For example, one kind of structured investment could protect an investor's principal, while allowing the investor to participate in the appreciation of an equity index, such as the S&P 500 Index. Another representative structured investment modifies the upside returns of the S&P 500 but not the downside; this structured investment may enhance upside return by giving an investor, for example, twice the positive return of the S&P 500 Index over a defined period up to a specified cap (e.g., double the return for the first 10% of appreciation of the index, for a maximum investor return of 20%, but no further participation). Structured investments have typically been offered in the form of note obligations or certificates of deposit (“CDs”). The present invention enables the offering of structured investment pay-off profiles through the use of investment companies.

Structured investments are very popular with consumer investors in Europe and Asia, and arguably may be the preferred investment vehicle for consumers in these regions. As a result of the heavy regulation of investment companies in the United States, to date structured investments have been offered in the United States primarily in note and CD form. Although consumer investors have purchased billions of dollars of structured investments in the United States over the last decade, that level of investment is dwarfed by the trillions of dollars of predominantly consumer assets under management in the mutual fund industry. Although investment professionals have advocated that consumer investors purchase more structured investment products, the prevalence of a “mutual fund culture” in the United States has slowed the penetration of structured investments in the form of notes and CDs. Widespread market acceptance of structured investments in the United States may require that structured investments be offered in the familiar form of a pooled investment vehicle or an investment company (an open-end investment company, closed-end investment company, or UIT). The described embodiments seek to make structured investments more accessible to consumer investors by delivering them through a pooled investment vehicle, leveraging the general comfort with mutual finds in the United States.

Structured investments deliver a defined pay-off profile at maturity. For a UIT to deliver a structured investment pay-off profile, the UIT holds derivative instruments along with other assets (e.g., stocks or bonds). Derivatives are financial instruments whose complexity is limitless. The challenge of incorporating derivatives into UITs for consumer investors is that of limiting that complexity. Consumer investors will only adopt this type of UIT if its material terms are readily understandable. For a UIT that offers a structured investment pay-off profile to be accessible to and adopted by consumer investors, that UIT must have a simple and clear marketing story. That marketing story must generally communicate in a few concise sentences all material details of the pay-off profile. The described embodiments enable a simple, but accurate, marketing description for a UIT.

Structured investments have a defined maturity and a pay-off profile at maturity which is determined by a variety of specified parameters, such as strike prices, barrier levels and caps. Typically associated with a structured investment is a defined and simple marketing story presented to investors at its issuance (e.g. principal protection, leveraged upside or buffered downside) which summarizes to an investor what the investor's investment experience will be, assuming the investor purchases the structured investment on its issuance date and holds it until its maturity date; typically, all economic parameters of the derivatives embedded in the structured investment are set no earlier than the issuance date. The investment experience of an investor who purchases a structured investment later than its issuance date and/or sells it before its maturity date will not generally coincide with that defined and simple marketing story that applies for an investor who holds the structured investment for its full term. In contrast to that simple marketing story, the marketing story for a structured investment whose economic parameters are fixed before the issuance date would generally be less crisp and more complex (e.g., see following example of Principal Protected investment linked to the S&P 500 Index™).

In order for consumer investor investment experience in a UIT to match the stated pay-off profile and associated marketing story of a structured investment in UIT form, all economic parameters of the derivatives in the UIT should be set no earlier than the time that proceeds from the sale of UIT units are invested in UIT assets. To establish a UIT, among other SEC requirements, the UIT must purchase the same instruments, typically in the same proportions, at seeding time and at investment time. This is relatively simple when the UIT holds traditional securities, such as stocks or bonds. At seeding time the UIT purchases a small number of the identified securities, and at investment time the UIT simply purchases more of the same identified securities, typically in the same proportions.

For a UIT to purchase a derivative that is not forward starting as part of its portfolio of assets, the UIT would purchase some of that derivative at seeding, and then more of that same derivative at investment time. As that derivative is not forward starting, all of the economic parameters of that derivative would have already been determined and specified at or prior to seeding, which is earlier than the time at which the proceeds from the sale of UIT units are invested in UIT assets. As a result, consumer investor investment experience would not coincide with the simple marketing story that would be most desirable for that particular pay-off profile. The described embodiments allow the UIT to invest seed money in a forward starting derivative—some of whose parameters are not determined until a later time—that time being no earlier than the time at which the proceeds from the sale of UIT units are invested in UIT assets.

A UIT with derivatives that are not forward starting will have a more complicated marketing story than a UIT with derivatives that are forward starting. A UIT with forward starting derivatives is preferable, because a simpler marketing story is vital to consumer investor product acceptance, and because product acceptance will be reinforced by actual consumer investment experience matching the consumer's expectation of the investment.

### EXAMPLE

### Principal Protected Investment Linked to the S&P 500 Index™

If this structured investment were delivered in the form of a note obligation, an investor would pay $1000 at inception, and would be promised at maturity a defined pay-off of $1000 if the S&P 500 index is at the same level as at issuance or lower, or otherwise the sum of (i) $1000, and (ii) the product of (x) $1000 and (y) a specified percentage (e.g., 80%) of the positive return of the S&P 500 index, calculated from the issuance date to the maturity date. For example, if the S&P 500 index is at 1250 on the issuance date and 1400 on the maturity date, an investor would expect a note pay-off equal to $1000+$1000*(80%*(1400−1250)/1250)=$1096.

Generally, to deliver the same structured investment pay-off profile in UIT form, the UIT would purchase assets, such as zero coupon bonds and over-the-counter call options on the S&P 500 index. If the seed capital were used to purchase a call option on the S&P 500 Index instead of a forward starting call option on the S&P 500 Index, then the consumer investor investment money would also have to be invested in an identical call option using the same strike that was set on the seed date. As a result the consumer investor cannot be offered protection in the amount of the proceeds from the sale of each UIT unit invested in UIT assets along with participation in any positive return of the S&P 500 Index starting at the index level on the investment date. To demonstrate this consider two scenarios. First, suppose the index moves up between the seed date and the investment date. A call option whose strike price was at-the-money when purchased on the seed date would now be in-the-money from the perspective of the consumer investor who purchases UIT units on the investment date. An in-the-money call option, unlike an at-the-money call option, has downside risk in the index from the index level on the investment date. As such, the consumer investor purchasing a UIT with an in-the-money call option is not indifferent to downside moves in the index, unlike an investor in a UIT that contains at-the-money call options. Second, suppose the index moves down between the seed date and the investment date. A call option whose strike price was at-the-money when purchased on the seed date would now be out-of-the-money from the perspective of the consumer investor who purchases UIT units on the investment date. An out-of-the-money call option, unlike an at-the-money call option, does not allow the investor to begin participating in immediate increases in the index, as there would be a gap between the current index level and the strike of the call option.

Calculation of NAV at Market Opening

Another embodiment changes the typical time for calculation of NAV. For most registered investment companies, the time set for calculating NAV is the close of trading, for example 4:00 p.m. EST. By calculating NAV at the close, investors who have placed orders to buy units of a registered investment company during the trading day know later that same day how many units of the investment company they will receive for a specified dollar investment, or the cost of a specified number of units they have decided to purchase. This is because the NAV determination at the end of the day is used. Similarly, investors who have requested a redemption of units in the investment company on a trading day will know on that same day the amount they will receive.

Although purchase orders and redemption requests are processed at the NAV determined at the close, the typical investment company may not receive notification of all the purchase orders and redemption requests for a given trading day until after the close. The first time at which the investment company can execute market transactions corresponding to the purchase orders and redemption requests may be at the following market open. Market prices are constantly changing. The market value at the close and the next open will differ. Therefore, there is a discrepancy between the market prices at the close used in computing NAV and the market prices at the open at which the investment company can execute market transactions. This discrepancy can be to the benefit or detriment of purchasing investors, remaining investors, or redeeming investors. Although each of an open-end investment company, closed-end investment company, and traditional UIT has a stated investment mandate, none of them are typically designed to deliver a specific, defined pay-off profile at a specific time; as such the discrepancy noted above can be tolerated in these investment vehicles.

However, for structured investments with a defined marketing story and a stated pay-off profile, that discrepancy would cause a divergence between the stated pay-off profile and the experienced return, and significantly detract from the simplicity of the marketing story because any story would be complicated by including an explanation of this divergence.

One embodiment sets the time for calculation of NAV at the open of trading (instead of the typical close of trading) so that the purchase or sale of UIT assets can be accomplished at the same price levels used in computing NAV, eliminating the discrepancy noted above.

In this embodiment, investors who want to redeem units of the UIT submit their requests before NAV is calculated, for example, during the trading day. The UIT receives those redemption requests and prepares to execute trades on the underlying instruments at the next open. The UIT does not calculate the NAV until the next open when the trades are also executed. The investor will receive the NAV for each unit on redemption. The UIT may receive the same amount of value as the calculated NAV as a result of sales by the UIT of the assets corresponding to the unit. The UIT receives an amount in respect of its asset sales that equals NAV, because the prices at which those asset sales are executed may inform the calculation of NAV.

Although illustrative embodiments have been described herein in detail, it should be noted and will be appreciated by those skilled in the art that numerous variations may be made within the scope of this invention without departing from the principle of this invention and without sacrificing its chief advantages.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

1. A method implemented by a programmed computer for establishing a unit investment trust, the unit investment trust providing a return that substantially tracks returns from at least two different financial instruments, the method comprising:
using the programmed computer to receive seed assets;
using the programmed computer to acquire at a first time a forward starting option on a first variable tracked by a financial market using at least some of the seed assets, the first variable representing a second financial instrument, wherein at least one term associated with the forward starting option is not determined at the first time;
using the programmed computer to engage in a transaction involving a first financial instrument;
using the programmed computer to receive investment capital as purchase orders for shares of the unit investment trust;
using the programmed computer to determine at a second time the at least one term associated with the forward starting option;
using the programmed computer to acquire at the second time an option on the first variable using at least a portion of the investment capital, wherein the at least one term associated with the forward starting option and at least one corresponding term associated with the options are the same; and
using the programmed computer to acquire more of the first financial instrument.

2. A method according to claim 1, wherein the unit investment trust is offered by a pooled investment vehicle.

3. A method according to claim 2, wherein the pooled investment vehicle is a registered investment company.

4. (canceled)

5. (canceled)

6. (canceled)

7. A method according to claim 1, wherein using the programmed computer to acquire at the second time the option on the first variable, and using the programmed computer to acquire more of the first financial instrument uses at least some of the investment capital.

8. A method according to claim 1, wherein using the programmed computer to acquire at the first time the forward starting option on the first variable further comprises using the programmed computer to acquire at the first time a forward starting call option on the first variable.

9. A method according to claim 1, wherein using the programmed computer to acquire at the first time the forward starting option on the first variable further comprises using the programmed computer to acquire at the first time a forward starting put option on the first variable.

10. A method according to claim 1, wherein using the programmed computer to acquire at the first time the forward starting option on the first variable further comprises using the programmed computer to acquire at the first time a forward starting exotic option on the first variable.

11. A method according to claim 1, wherein the transaction consists of purchasing the first financial instrument.

12. A method according to claim 1, wherein the transaction consists of purchasing the first financial instrument.

13. A method according to claim 1, wherein using the programmed computer to acquire at the second time the option on the first variable further comprises using the programmed computer to acquire at the second time a call option on the first variable.

14. A method according to claim 1, wherein using the programmed computer to acquire at the second time the option on the first variable further comprises using the programmed computer to acquire at the second time a put option on the first variable.

15. A method according to claim 1, wherein using the programmed computer to acquire at the second time the option on the first variable further comprises using the programmed computer to upsize the previously acquired forward starting option.

16. A method according to claim 1, wherein using the programmed computer to acquire more of the first financial instrument further comprises using the programmed computer to acquire more of the first financial instrument with a portion of the investment capital.

17. A method according to claim 1, wherein the second time is one or more days after the first time.

18. A method according to claim 1, wherein using the programmed computer to engage in the transaction involving the first financial instrument occurs at the first time.

19. A method according to claim 1, wherein using the programmed computer to acquire more of the first financial instrument occurs at the second time.

20. A method according to claim 1, wherein strike price is one of the predefined terms that is the same.

21. (canceled)

22. A method according to claim 1, wherein counterparty is one of the predefined terms that is the same.

23. A method according to claim 1, wherein using the programmed computer to acquire the first financial instrument further comprises using the programmed computer to acquire at the first time a forward starting option on a second variable tracked by a financial market, wherein the second variable represents the first financial instrument.

24. A method according to claim 1, wherein using the programmed computer to acquire more of the first financial instrument further comprises using the programmed computer to acquire at the second time a call option on the first financial instrument.

25. A method according to claim 1, wherein using the programmed computer to acquire more of the first financial instrument further comprises using the programmed computer to acquire at the second time a put option on the first financial instrument.

26. A method according to claim 1, further comprising filing a registration statement for the structured investment product after using the programmed computer to acquire at the first time the forward starting option.

27. A method implemented a programmed computer for establishing a structured investment product, the investment product providing a return that substantially tracks returns from at least two different financial instruments, the method comprising:
using the programmed computer to receive seed assets;
using the programmed computer to acquire at a first time a first forward starting option on a first variable tracked by a financial market using at least a portion of the seed assets, the first variable representing a second financial instrument, wherein at least one term associated with the forward starting option is not determined at the first time;
using the programmed computer to acquire a first financial instrument;
using the programmed computer to receive investment capital as purchase orders for shares of the structured investment product;
using the programmed computer to determine at a second time the at least one term associated with the first forward starting option;
using the programmed computer to acquire at the second time a second forward starting option on the first variable tracked by a financial market using at least a portion of the investment capital, wherein the at least one term associated with the first forward starting option and at least one corresponding term associated with the second forward starting option are the same; and
using the programmed computer to acquire more of the first financial instrument.

28. A method implemented by a programmed computer for establishing a structured investment product, the investment product providing a return that substantially tracks returns from at least two different financial instruments, the method comprising:
using the programmed computer to receive seed assets;
using the programmed computer to acquire at a first time a forward starting derivative on a first variable tracked by a financial market using at least a portion of the seed assets, the first variable representing a second financial instrument, wherein at least one term associated with the forward starting derivative is not determined at the first time;
using the programmed computer to acquire a first financial instrument;
using the programmed computer to receive investment capital as purchase orders for shares of the structured investment product;
using the programmed computer to determine at a second time the at least one term associated with the first forward starting derivative;
using the programmed computer to acquire at the second time a derivative on the first variable using at least a portion of the investment capital, wherein the at least one term associated with the forward starting option and at least one corresponding term associated with the derivative are the same, and
using the programmed computer to acquire more of the first financial instrument.

29. A method according to claim 28, wherein the forward starting derivative is a forward starting option, and the derivative is an option.

30. A method according to claim 28, wherein the forward starting derivative is a forward starting forward, and the derivative is a forward.

31. A method according to claim 28, wherein the forward starting derivative is a forward starting swap, and the derivative is a swap.

32. A method implemented by a programmed computer for establishing a structured investment product, the investment product providing a return that substantially tracks returns from at least two different financial instruments, the method comprising:
using the programmed computer to receive seed assets;
using the programmed computer to acquire at a first time a first forward starting derivative on a first variable tracked by a financial market using at least a portion of the seed assets, the first variable representing a second financial instrument, wherein at least one term associated with the forward starting derivative is not determined at the first time;
using the programmed computer to acquire a first financial instrument;
using the programmed computer to receive investment capital as purchase orders for shares of the structured investment product;
using the programmed computer to determine at a second time the at least one term associated with the first forward starting derivative;
using the programmed computer to acquire at a second time a second forward starting derivative on the first variable using at least a portion of the investment capital, wherein the at least one term associated with the forward starting option and at least one corresponding term associated with second forward starting derivative are the same; and
using the programmed computer to acquire more of the first financial instrument.

33. (canceled)

34. (canceled)

35. A computer-readable medium having computer executable software code stored thereon, the code for establishing a structured investment product, the investment product providing a return that substantially tracks returns from at least two different financial instruments, the code comprising:
code to receive seed assets;
code to acquire at a first time a forward starting option on a first variable tracked by a financial market using at least portion of the seed assets, the first variable representing a second financial instrument, wherein at least one term associated with the forward starting derivative is not determined at the first time;
code to acquire a first financial instrument;
code to receive investment capital as purchase orders for shares of the structured investment product;
code to determine at a second time the at least one term associated with the first forward starting derivative;
code to acquire at a second time an option on the first variable using at least a portion of the investment capital, wherein the at least one term associated with the forward starting option and at least one corresponding term associated with the option are the same; and
code to acquire more of the first financial instrument.

36. A programmed computer for establishing a structured investment product, the investment product providing a return that substantially tracks returns from at least two different financial instruments, comprising:
a memory having at least one region for storing computer executable program code; and
a processor for executing the program code stored in the memory, wherein the program code comprises:
code to receive seed assets;
code to acquire at a first time a forward starting option on a first variable tracked by a financial market using at least portion of the seed assets, the first variable representing a second financial instrument, wherein at least one term associated with the forward starting option is not determined at the first time;
code to acquire a first financial instrument;
code to receive investment capital as purchase orders for shares of the structured investment product;
code to determine at a second time the at least one term associated with the first forward starting derivative;
code to acquire at the second time an option on the first variable, wherein the at least one term associated with the forward starting option and at least one corresponding term associated with the option are the same; and
code to acquire more of the first financial instrument.

37. A method implemented by a programmed computer for establishing a structured investment product, the method comprising:
using the programmed computer to receive seed assets;
using the programmed computer to acquire at a first time a forward starting option on a first variable tracked by a financial market using at least a portion of the seed assets, wherein at least one term associated with the forward starting option is not determined at the first time;
using the programmed computer to receive investment capital as purchase orders for shares of the structured investment product; and
using the programmed computer to determine at a second time the at least one term associated with the first forward starting derivative;
using the programmed computer to acquire at the second time an option on the first financial variable with at least a portion of the investment capital, wherein the at least one term associated with the forward starting option and at least one corresponding term associated with the option are the same.

38. A method according to claim 37, further comprising using the programmed computer to acquire at the first time a forward starting option on a second variable tracked by a financial market.

39. A method according to claim 37, further comprising using the programmed computer to acquire at the second time an option on a second variable tracked by a financial market.

40. A method according to claim 37, wherein the first variable comprises a basket of variables.

41. A method according to claim 37, wherein the forward starting option is a forward starting put option.

42. A method according to claim 37, wherein the forward starting option is a forward starting call option.

43. A method according to claim 37, wherein the forward starting option is a forward starting combination of a put and a call option.

44. A method according to claim 37, wherein the forward starting option is a forward starting combination of multiple put options.

45. A method according to claim 37, wherein the forward starting option is a forward starting combination of multiple call options.

46. A method according to claim 37, wherein the forward starting option is a forward starting combination of multiple put and multiple call options.

47. A method according to claim 37, wherein using the programmed computer to acquire at a second time an option on the financial variable further comprises using the programmed computer to upsize the previously acquired forward starting option.
